(19) United States
(12) Patent Application Publication
(10) Pub. No.: US 2019/0077226 A1
(43) Pub. Date: Mar. 14, 2019

(54) HUSH PANEL ASSEMBLY WITH INTEGRATED AIR DUCT

(71) Applicant: FORD GLOBAL TECHNOLOGIES, LLC, Dearborn, MI (US)

(72) Inventors: Manfred Koberstein, Troy, MI (US); Jennifer A. Herr-Rathke, Plymouth, MI (US); Jose A. Nava, Plymouth, MI (US); Benjamin John Keur, Northville, MI (US); Michael Murphy McElroy, South Lyon, MI (US); Kyle David Ruffer, Allen Park, MI (US)

(21) Appl. No.: 15/698,710

(22) Filed: Sep. 8, 2017

(51) Int. Cl. B60H 1/24; B60H 1/34

(52) U.S. Cl. CPC B60H 1/242; B60H 2001/00214; B60H 1/34

(57) ABSTRACT

A hush panel assembly includes an upper section, a lower section secured to the upper section and an airflow pathway. That airflow pathway is defined between the upper section and the lower section. In addition, the lower section is made from an air permeable material through which air is distributed to a footwell of a motor vehicle.

### TECHNICAL FIELD

This document relates generally to the motor vehicle equipment field and, more particularly, to a hush panel assembly that incorporates an integrated air duct.

### BACKGROUND

Packaging space in motor vehicle instrument panels has become tighter with the addition of vehicle telematics, safety components like knee airbags and new styling themes. Air ducts to the footwell areas have to be packaged within these space limitations and still provide for driver and passenger comfort. Limited space results in ducts with smaller effective cross-sectional areas and multiple bends that create more restriction that reduces airflow volume. These factors contribute to increased time for vehicle occupants to achieve thermal comfort, degrade air rush noise characteristics and consume more system power.

This document relates to a new and improved hush panel assembly that more efficiently and effectively utilizes available package space under the instrument panel to distribute airflow to the footwell areas of the motor vehicle. Advantageously, the hush panel assembly incorporates an integrated air duct thereby eliminating the need for a separate duct component as used in state of the art motor vehicles. Advantageously, the hush panel assembly also distributes air through the lower section of the hush panel assembly so as to provide better air distribution across the footwell.

### SUMMARY

In accordance with the purposes and benefits described herein, a new and improved hush panel assembly is provided. That hush panel assembly comprises (a) an upper section, (b) a lower section secured to the upper section and (c) an airflow pathway defined between the upper section and the lower section. The lower section is made from an air permeable material through which air is distributed to a footwell of a motor vehicle.

The air permeable material may have an air permeability of at least 3.0 L/s at a pressure of 150 Pascals. In some embodiments, the air permeable material may have an air permeability of between 3.3 and 8.0 L/s at a pressure of 150 Pascals.

In one of many possible embodiments the air permeable material of the hush panel assembly may be a non-woven material. Further, the non-woven material may comprise compressed polyethylene terephthalate.

In some of the many possible embodiments, the upper section may be made from a closed cell, flexible foam material. In other possible embodiments, the upper section may be made from a stamped fibrous material. In some possible embodiments, the upper section may be made from non-woven, compressed polyethylene terephthalate. In such embodiments the upper section may also include an air impermeable plastic sheet. Preferably that air impermeable plastic sheet is oriented toward the airflow pathway thereby forming an inner wall of the integrated air duct or airflow pathway of the hush panel assembly.

In some of the many possible embodiments, the upper section is made from polypropylene filled with talc. In some of the many possible embodiments, the upper section is made from polypropylene. In some of the many possible embodiments, the upper section is made from acrylonitrile butadiene styrene (ABS).

The upper section and the lower section of the hush panel assembly may be connected together in any appropriate manner. In some embodiments, the hush panel assembly includes a press fit feature for securing the upper and lower sections together. That press fit feature may include cooperating dimples and receivers. Further, the dimples may be provided on the lower section and the receivers may be provided on the upper section.

Still further, the lower section of the hush panel assembly may include an exposed face having a textured surface that is similar in appearance to the carpet in the footwell. In this way it is possible to provide a more uniform and aesthetically pleasing appearance.

In the following description, there are shown and described several preferred embodiments of the hush panel assembly. As it should be realized, the hush panel assembly is capable of other, different embodiments and its several details are capable of modification in various, obvious aspects all without departing from the hush panel assembly as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the hush panel assembly and together with the description serve to explain certain principles thereof.

FIG. 1 is an exploded perspective view illustrating the upper and lower sections of the hush panel assembly and the two sections of the air feed duct that deliver air from the heating, ventilating and air conditioning (HVAC) system to the integrated air duct or airflow pathway defined between the two sections of the hush panel assembly.

FIG. 2 is a perspective view of the components of FIG. 1 in an assembled condition.

FIG. 3 is a top plan view of the components of FIG. 1 in an assembled condition.

FIG. 4 is a schematic illustration of the airflow pathway formed between the two sections of the hush panel assembly.

FIG. 5 is a partially cross-sectional view illustrating one possible press fit feature for securing the upper section and lower section of the hush panel assembly together.

Reference will now be made in detail to the present preferred embodiments of the hush panel assembly, examples of which are illustrated in the accompanying drawing figures.

### DETAILED DESCRIPTION

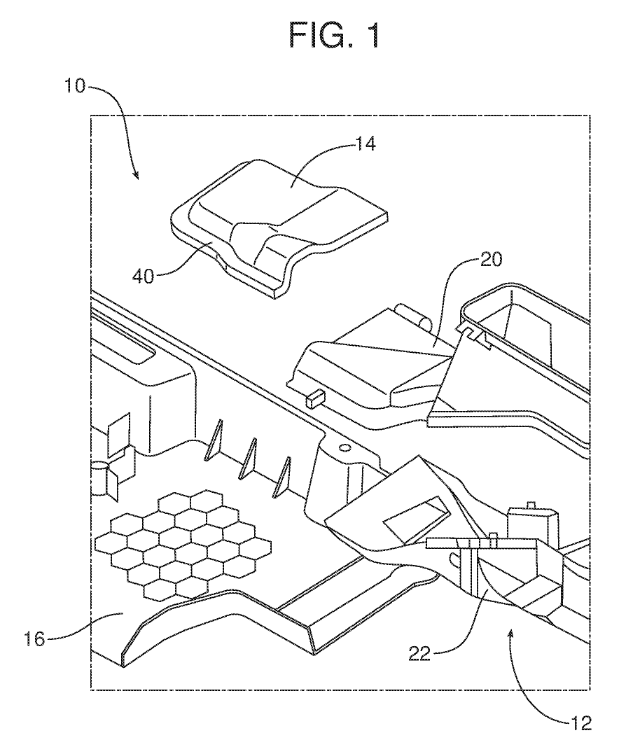

Reference is now made to FIGS. 1-5 illustrating a new and improved hush panel assembly 10 as well as the air feed duct 12 to which the hush panel assembly 10 is connected. The air feed duct 12 feeds conditioned air from the HVAC system of the motor vehicle to the hush panel assembly 10.

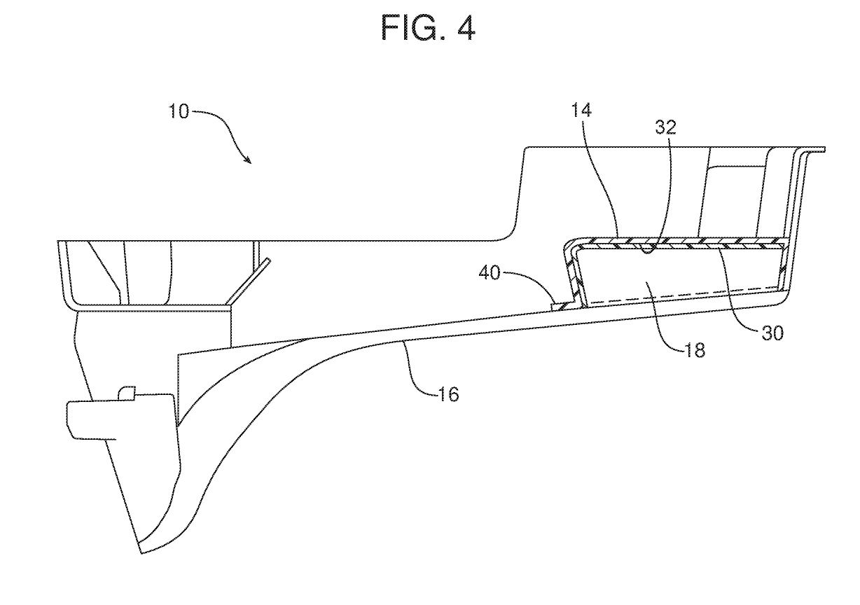

As best illustrated in FIGS. 1 and 4, the hush panel assembly 10 includes a first or upper section 14, a second or lower section 16 secured to the upper section and an airflow pathway 18 defined between the upper section and the lower section. The air feed duct 12 includes a first section 20 and a second section 22.

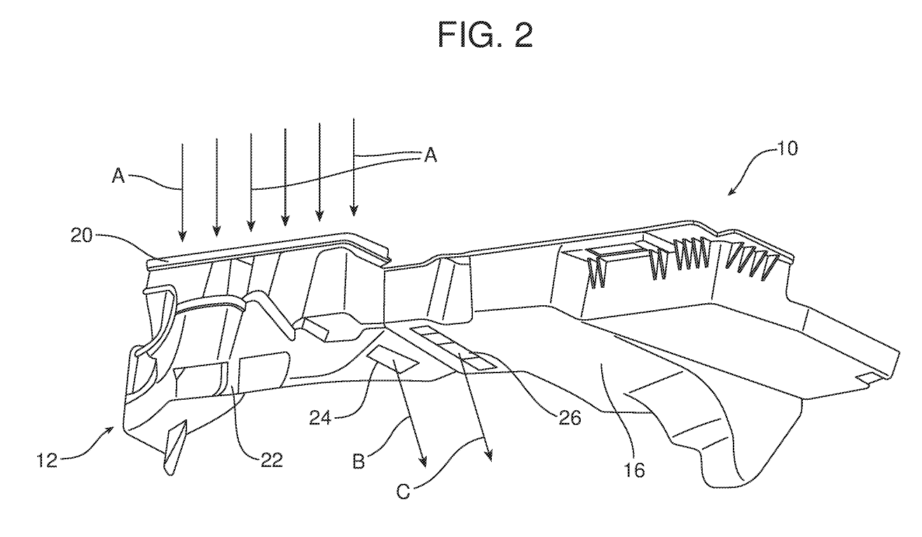

When the hush panel assembly 10 and the air feed duct 12 are fully assembled as illustrated in FIG. 2, airflow from the HVAC system (note action arrows A) is directed by the air feed duct 12 through a first discharge outlet 24 in the second section 22 (note action arrow B) and into the integrated air duct or airflow pathway 18 of the hush panel assembly 10 (see FIG. 4). The airflow delivered to the airflow pathway 18 of the hush panel assembly 10 is then directed toward and discharged from a second discharge outlet 26 (see action arrow C) in the lower section 16 of the hush panel assembly 10. The airflow passing through the first and second discharge outlets 24, 26 is delivered into the underlying footwell.

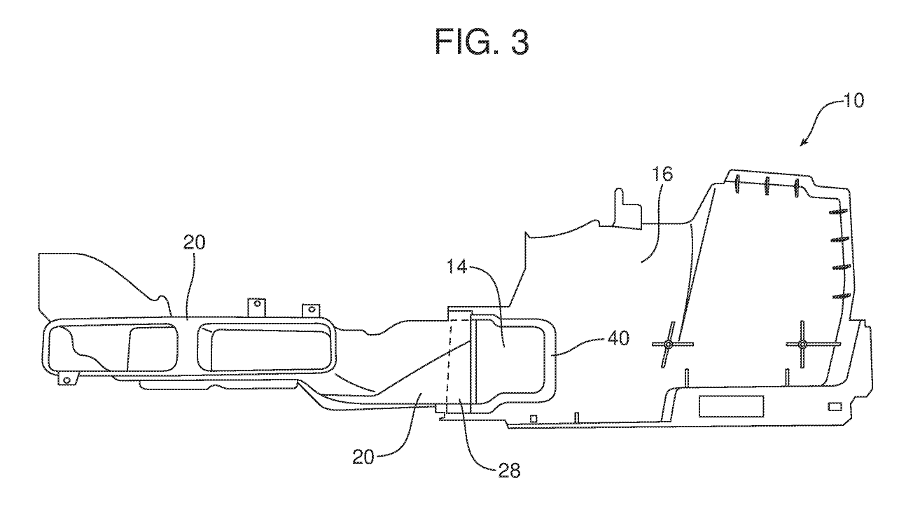

FIG. 3 is a top plan view of the assembled hush panel assembly 10 and air feed duct 12 showing the position of the upper section 14 on the lower section 16 and the lap joint 28 formed between the first section 20 of the air feed duct 12 and the upper section 14 of the hush panel assembly 10. FIG. 4 clearly illustrates the airflow pathway 18 formed between the upper section 14 and lower section 16. As noted above, the airflow pathway 18 delivers airflow from the air feed duct 12 to the second discharge outlet 26 in the lower section 16.

The lower section 16 of the hush panel assembly 10 may be made from an air permeable material through which air may be distributed to the footwell of the motor vehicle. More specifically, the air permeable material has an air permeability of at least 3.0 L/s at a pressure of 150 Pascals. In some embodiments the air permeable material has an air permeability of between 3.3 and 8.0 L/s at a pressure of 150 Pascals.

A lower section 16 with air permeability within this range allows for the directing of a large portion of the airflow to the second discharge outlet 26 while advantageously allowing a small portion of the airflow to actually pass through the lower section 16. The resulting diffusion of air through the lower section 16 ensures better air distribution across the footwell for enhanced occupant comfort.

Toward this end, the air permeable material of the lower section 16 may be a non-woven material such as compressed polyethylene terephthalate. Non-woven compressed polyethylene terephthalate provides improved noise vibration harshness (NVH) when compared to expanded polypropylene used for the construction of prior art hush panels.

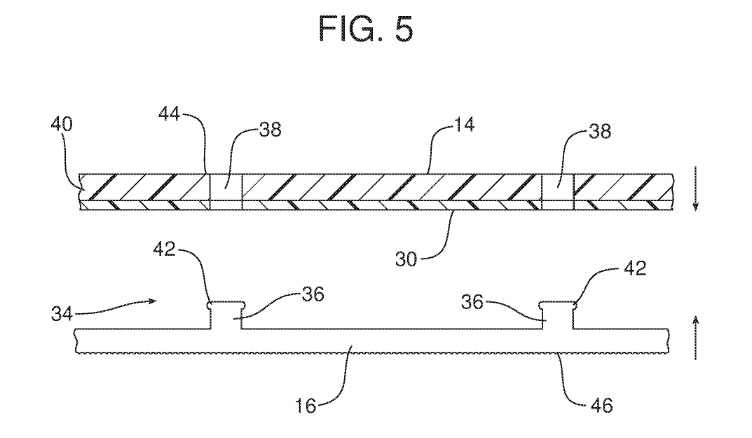

The upper section 14 of the hush panel assembly may be made from an air impermeable material. Toward this end, in some embodiments the upper section 14 is made from a closed cell, flexible foam material. In other possible embodiments, the upper section 14 may be made from a stamped fibrous material. In still other possible embodiments, the upper section 14 may be made from a non-woven, compressed polyethylene terephthalate that includes an air impermeable plastic sheet 30 such as a sheet of Mylar material. As illustrated in FIGS. 4 and 5, the air impermeable plastic sheet 30 may be provided on the lower, duct side or face 32 of the upper section 14.

In some possible embodiments, the upper section 14 is made from polypropylene filled with talc. In other possible embodiments, the upper section 14 is made from polypropylene. In still other possible embodiments, the upper section 14 is made from acrylonitrile butadiene styrene (ABS).

The upper section 14 and the lower section 16 of the hush panel assembly 10 may be secured or connected together in any appropriate manner. As illustrated in FIG. 5, the hush panel assembly 10 may include a press fit feature 34 adapted to secure the upper section 14 to the lower section 16. In the illustrated embodiment, that press fit feature 34 includes cooperating dimples, 36 and receivers 38. More specifically, the dimples 36 may be molded into the lower section 16 and the receivers 38 may comprise matching apertures formed in the securing flange 40 (see FIGS. 1, 3 and 4) provided around the perimeter of the upper section 14 abutting the lower section 16. As should be appreciated, the dimples 36 are pressed through the receivers 38 and the enlarged heads 42 of the dimples lap the upper face 44 of the upper section 14 to secure the connection.

As further illustrated in FIG. 5, the lower or exposed face 46 of the lower section 16 may be a textured surface adapted to closely resemble carpeting provided in the footwell over which the lower section 16 is positioned. This ensures a uniform and aesthetically pleasing appearance appreciated by occupants of the motor vehicle.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A hush panel assembly, comprising:
a first section;
a second section secured to said first section; and
an airflow pathway defined between said first section and said second section wherein said second section is made from an air permeable material through which air is distributed in a footwell in a motor vehicle.

2. The hush panel assembly of claim 1, wherein said air permeable material has an air permeability of at least 3.0 L/s at a pressure of 150 Pascals.

3. The hush panel assembly of claim 2, wherein said air permeable material is a non-woven material.

4. The hush panel assembly of claim 3, wherein said air permeable material is compressed polyethylene terephthalate.

5. The hush panel assembly of claim 2, wherein said first section is made from a closed cell, flexible foam material.

6. The hush panel assembly of claim 2, wherein said first section is made from a stamped fibrous material.

7. The hush panel assembly of claim 2, wherein said first section is made from non-woven, compressed polyethylene terephthalate.

8. The hush panel assembly of claim 7, wherein said first section includes an air impermeable plastic sheet.

9. The hush panel assembly of claim 8, wherein said air impermeable plastic sheet is oriented toward said airflow pathway.

10. The hush panel assembly of claim 2, wherein said first section is made from polypropylene filled with talc.

11. The hush panel assembly of claim 2, wherein said first section is made from polypropylene.

12. The hush panel assembly of claim 2, wherein said first section is made from acrylonitrile butadiene styrene (ABS).

13. The hush panel assembly of claim 1, further including a press fit feature securing said second section to said first section.

14. The hush panel assembly of claim 13, wherein said press fit feature includes cooperating dimples and receivers.

15. The hush panel assembly of claim 14, wherein said dimples are provided on said second section and said receivers are provided on said first section.

16. The hush panel assembly of claim 15, wherein said second section includes an exposed face having a textured surface.

17. The hush panel assembly of claim 1, wherein said second section includes an exposed face having a textured surface.

18. The hush panel assembly of claim 1, wherein said air permeability material has an air permeability of between 3.3 and 8.0 L/s at a pressure of 150 Pascals.

19. The hush panel assembly of claim 1, further including a lap joint between said first section and an air feed duct of said motor vehicle.
